(19) United States
(12) Patent Application Publication
(10) Pub. No.: US 2009/0098272 A1
(43) Pub. Date: Apr. 16, 2009

(54) Nutritional Beverages

(76) Inventor: Hermanus Theodorus K M Banken, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/084,926

(22) PCT Filed: Nov. 7, 2006
(86) PCT No.: PCT/EP2006/010675

§ 371 Date: May 13, 2008

(30) Foreign Application Priority Data
Nov. 14, 2005 (EP) 05077588.1
Nov. 14, 2005 (EP) 05077589.9
Mar. 1, 2006 (EP) 06075464.5
Mar. 3, 2006 (EP) 06075496.7
Apr. 21, 2006 (EP) 06075940.4

(51) Int. Cl. A23L 2/66; A23L 1/29; A23L 1/304

(52) U.S. Cl. 426/590

(57) ABSTRACT

One aspect of the invention relates to a sterilized nutritional beverage product comprising: • from 0.5-8.0 wt. % protein; • from 0.1-10 wt. % of dispersed fat; • from 0.2-4.0 wt. % of starch component; • from 0.01-2.0 wt. % of fatty acid emulsifier; • from 0.01-2.5 wt. % of non-dissolved edible salt; • from 0.005-0.5 wt. % of a hydrocolloid selected from the group consisting of carrageenan, guar gum, carboxymethyl cellulose, microcrystalline cellulose and combinations thereof; • from 0-8.0 wt. % of other nutritional components; and • 70-90 wt. % water. The invention provides a sterilised nutritionally balanced beverage, which beverage exhibits excellent stability even when stored for several weeks under tropical conditions. Furthermore, despite the high content of solutes and biopolymers, said beverage produces a pleasant mouthfeel. The invention also provides a process for the manufacture of the aforementioned beverage.

### TECHNICAL FIELD OF THE INVENTION

The present invention relates to a sterilised nutritional beverage containing protein, fat, carbohydrates, non-dissolved salts and water. The present beverage has a pleasant mouthfeel and can be stored under tropical conditions for several weeks without showing signs of destabilisation. In particular, the nutritional beverage of the present invention exhibits exceptional stability against sedimentation, oil separation, flocculation and creaming. Furthermore, also the rheological properties of the beverage do not change significantly during storage under extreme conditions.

### BACKGROUND OF THE INVENTION

Nutritional beverages containing protein, fat and carbohydrates and non-dissolved salts are known in the art. During processing, transportation and storage of these beverages sedimentation of the non-dissolved salts is likely to occur. Such sedimentation is undesirable because it adversely affects the appearance of the product. Furthermore, the sediment is often not consumed, meaning that nutritionally important minerals (e.g. calcium, iron etc.) that are contained in the sediment are not ingested.

Another form of instability that can give rise to serious product quality problems is destabilization of the dispersed oil phase. These emulsion stability problems are, for instance, caused by flocculation, creaming and/or coalescence of the dispersed oil droplets. These dynamic phenomena can dramatically affect the appearance and sensory characteristics of the beverages.

Thermodynamically speaking, oil-in-water emulsions are metastable systems which means that they are prepared using excess energy (mechanical in most cases). After a period of time which depends strongly on the preparation method and the product composition, the emulsion eventually phase separates in two phases. The phase separation involves coalescence of the oil droplets which grow as a function of time. This is an irreversible process.

Besides coalescence, oil-in-water emulsions often exhibit other types of destabilisation, notably flocculation and creaming. Flocculation, like coalescence, is a mechanism that involves the coming together of oil droplets. However, in case of flocculation no coalescence is observed, i.e. the oil droplets form aggregates that separate from the bulk. Creaming occurs in oil-in-water emulsions because the density of the oil droplets is lower than that of the continuous aqueous phase into which they have been dispersed. Due to this density difference, there is driving force that gradually moves the oil droplets to the top surface of the product.

As will be clear from the above, it is impossible to completely prevent the occurrence of coalescence, flocculation and creaming in oil-in-water emulsions such as the present nutritional beverage. However, by reducing the rate at which these phenomena occur, sufficient product stability can be achieved to ensure that product quality will remain acceptable throughout the product's shelf-life.

The speed at which coalescence, flocculation and creaming occur in oil-in-water emulsions increases rapidly with temperature increase. Another factor that accelerates these destabilisation phenomena are high solute concentrations in the aqueous phase. Nutritional beverages typically comprise aqueous phases with high solute concentrations due to the presence of substantial levels of proteins and carbohydrates.

Thus, it is a major challenge to provide nutritional beverages in the form of oil-in-water emulsions that can be stored for several weeks under tropical conditions without developing serious stability defects. In order to provide a nutritional beverage that can be stored for several weeks under tropical conditions, before being consumed, it must be ensured that no microbial spoilage occurs during this period. Effectively, this means that the product must be sterilised and packaged under aseptic conditions. Since sterilisation conditions favour coalescence of oil droplets, the product needs to be formulated in such a way that coalescence of oil droplets and sedimentation of non-dissolved salts is not only prevented during storage and handling under tropical conditions, but also during sterilisation.

In order to minimise one or more of the aforementioned destabilization phenomena, it has been suggested in the prior art to employ thickening agents, emulsifiers etc. These ingredients affect the rheological properties of the product, e.g. the viscosity. However, during storage, especially under tropical conditions, the rheological properties of beverages containing these thickening agents and/or emulsifiers tend to change quite noticeably. Often, the viscosity of the product increases in time until it reaches an unacceptable level. In some instances, beverages were actually found to form a gel during storage. These changes in rheological properties are believed to result from dynamic interactions between thickening agents and emulsifiers or by interactions of these ingredients with other ingredients of the beverage.

U.S. Pat. No. 6,475,539 describes a shelf stable liquid enteral formula having a pH of from about 3.0-4.6 comprising:

(a) from about 45-95% by weight water;
(b) from about 1.0-15% by weight of caseinate
(c) from 0.5-3.3% by weight of high methoxy pectin;
(d) from about 1-30% by weight of a carbohydrate;
(e) from about 0.5-10% by weight of an edible oil;
(f) sufficient quantities of protein, carbohydrate, and edible oil to serve as a sole source of nutrition, in a volume ranging from 1000-2000 ml,
(g) at least 100% of the adult RDI for vitamins and minerals, in a volume ranging from 1000-2000 ml, and;
(h) and said enteral formula has a shelf life of at least one year. The carbohydrate is preferably selected from the group consisting of dextrose, lactose, fructose, sucrose, maltose, corn starch, hydrolysed corn starch, maltodextrin, glucose polymers, corn syrup solids, oligosaccharides, high saccharides, high fructose corn syrup, and fructooligosaccharides. It is observed in the US patent that one aspect of the invention described therein relates to process of manufacture which produces a beverage with excellent physical stability even after retort sterilisation, aseptic packaging and hot-fill processes.

It is an objective of the present invention to provide a sterilised nutritionally balanced beverage that contains protein, carbohydrates, fat and non-dissolved salts, which beverage exhibits excellent stability even when stored for several weeks under tropical conditions. Furthermore, it is an objective to provide a sterilised beverage that, despite the high content of solutes and biopolymers, produces a pleasant mouthfeel.

### SUMMARY OF THE INVENTION

The present inventors have realised these objectives by developing a carefully balanced formulation. More particularly, the inventors have provided a nutritional beverage containing:
a) from 0.5-8.0 wt. % protein;
b) from 0.1-10 wt. % of dispersed fat;
c) from 0.2-4 wt. % of starch component selected from the group consisting of native starch, modified starch and combinations thereof;
d) from 0.01-2.0 wt. % of fatty acid emulsifier;
e) from 0.01-2.5 wt. % of non-dissolved edible salt;
f) from 0.005-0.5 wt. % of a hydrocolloid selected from the group consisting of carrageenan, guar gum, carboxymethyl cellulose, microcrystalline cellulose and combinations thereof;
g) from 0-8.0 wt. % of other nutritional components; and
h) 70-90 wt. % water.

Although the inventors do not wish to be bound by theory, it is believed that the combination of starch component, fatty acid emulsifier and hydrocolloid fulfils a critical role in stabilising the present nutritional product against sedimentation of the non-dissolved salt. Furthermore, this combination provides exceptional emulsion stability despite the fact that the present beverages contain high levels of solute. Moreover, although the aforementioned combination of ingredients can render the present beverage rather viscous, the viscosity and other rheological parameters of the product remain stable irrespective of the temperature at which the product is stored. Finally, the present product has a very pleasant mouthfeel, despite the fact that it contains high levels of solutes, biopolymer and even non-dissolved salts.

The present invention also provides a method of manufacturing such a nutritional beverage as described above, said method comprising:
combining the protein, fat, starch component, fatty acid emulsifier, hydrocolloid, non-dissolved salt, optional other nutritional components and water in a pre-emulsion;
homogenising the pre-emulsion; and
sterilising the homogenised pre-emulsion by heating it to a temperature of more than 130° C. for 2-30 seconds.

### DETAILED DESCRIPTION OF THE INVENTION

Accordingly, one aspect of the invention relates to a sterilized nutritional beverage product comprising:
a) from 0.5-8.0 wt. %, preferably from 1.0-6.0 wt. % protein;
b) from 0.1-10 wt. %, preferably from 1.0-6.0 wt. % of dispersed fat;
c) from 0.2-4.0 wt. %, preferably from 0.5-3.0 wt. % of starch component selected from the group consisting of native starch, modified-starch and combinations thereof;
d) from 0.01-2.0 wt. %, preferably from 0.05-1.2 wt. % of fatty acid emulsifier;
e) from 0.01-2.5 wt. %, preferably from 0.5-1.0 wt. % of non-dissolved edible salt;
f) from 0.005-0.5 wt. %, preferably from 0.01-0.3 wt. % of a hydrocolloid selected from the group consisting of carrageenan, guar gum, carboxymethyl cellulose, microcrystalline cellulose and combinations thereof;
g) from 0-8.0 wt. % of other nutritional components; and h) 70-90 wt. % water.

The terms “fat” and “oil” as used herein are synonyms and refer to triglycerides.

The term “native starch” as used herein refers to a starch that has been isolated from a natural plant source and that has not been hydrolysed or chemically modified.

The term “modified starch” refers to a starch that has been chemically modified, e.g. by esterification. The term “modified starch” does not encompass starches that have been altered exclusively by means of hydrolysis. Thus, neither the term “native starch” nor the term “modified starch” encompasses hydrolysed starches such as maltodextrins.

The term “fatty acid emulsifier” refers to an emulsifier that contains at least one fatty acid residue, especially at least on fatty acid residue with a carbon chain length of at least 8 carbon atoms.

The terminology “non-dissolved salt” refers to salts that are present in the nutritional beverage in non-dissolved form. In order to prevent sedimentation, these non-dissolved salts need to be kept suspended in the beverage.

The combination of protein, carbohydrate and fat, typically represents at least 6 wt. %, preferably at least 8 wt. % and most preferably at least 10 wt. % of the present nutritional beverage.

According to a particularly preferred embodiment, the present beverage product contains at least 0.1 wt. %, more preferably at least 0.2 wt. % and most preferably at least 0.3 wt. % of fatty-acid emulsifier.

Examples of fatty acid emulsifiers that may advantageously be employed in the present beverage include monoglycerides, diglycerides, esters of monoglycerides and food acids, esters of monoglycerides and food acids and combinations of these emulsifiers. Examples of suitable food acids include citric acid and tartaric acid.

According to a particularly preferred embodiment, the fatty acid emulsifier is selected from the group consisting of monoglycerides, diglycerides and combinations thereof.

In accordance with another preferred embodiment, the fatty acid emulsifier has an iodine value of less than 12, more preferably of less than 6. Although the inventors do not wish to be bound by theory, it is believed that emulsifiers containing saturated fatty acid residues, especially saturated monoglycerides, can form stable complexes with the starch component, thus preventing, for instance, amylose retrogradation. Amylose retrogradation is inevitably accompanied by viscosity changes.

Typically, the emulsifiers employed in the present product have an HLB of 1-12. Particularly good stability can be achieved if the fatty acid emulsifier contained in the present beverage has an HLB of 3-10.

The hydrocolloids employed in the present beverage helps to prevent sedimentation of the non-dissolved salt. It was found that carrageenan is particularly effective in preventing salt sedimentation. Hence, in a preferred embodiment, the hydrocolloid is carrageenan. Preferably, carrageenan is incorporated in a concentration of 0.01-0.2 wt. %. Carrageenan is a complex carbohydrate extracted from red seaweed and is believed to provide stability in the present nutritional beverage through interaction with the protein, causing the formation of very weak thixotropic gels at low concentrations.

The non-dissolved edible salt is suitably selected from the group consisting of iron salts, calcium salts, zinc salts and combinations thereof. According to a particularly preferred embodiment, the non-dissolved salt is selected from the group consisting of iron-fumarate, iron pyrophosphate, calcium phosphate, calcium carbonate and combinations thereof.

Examples of modified starches that may suitably be incorporated in the present beverage include esterified starches, crosslinked starches, oxidised starches, succinate modified starches and pregelatinised starches and combinations of these modified starches. It should be understood that the present invention also encompasses the use of starches that have undergone multiple modifications, e.g. crosslinked hydroxyalkylated starches. Typical examples of esterified starches include acetylated, hydroalkylated, phosphorylated and succinated starches. Most preferably, the modified starch is a cross-linked or esterified starch.

The native starch applied in the present nutritional beverage may be obtained from various plant sources known in the art, such as potato, tapioca and maize. Preferably, the native starch is a native maize starch. Most preferably, the native starch is a native waxy maize starch.

The pH of the present beverage product can vary within a broad range, e.g. between 3.0 and 7.5. Preferably, the pH of the beverage product is within the range of 4.7-8.0, most preferably of 5.0-7.5. The problems associated with the presence of non-dissolved salts are generally much less pronounced in low pH products. Hence, the advantages of the present invention are particularly pronounced in non-acidified or slightly acidified beverage products.

The exceptional stability of the present beverage is also believed to be associated with the combined use of protein and starch component in the indicated concentrations. Particularly good results have been obtained if the protein employed is dairy protein. Examples of suitable sources of dairy protein include milk, whey, skim milk, cheese, curd, casein, caseinate. Preferably, the present composition contains a source of dairy protein selected from the group consisting of milk, whey, skim milk, casein, caseinate and combinations thereof. These materials may be incorporated in the present beverage in dehydrated or liquid form, preferably in dehydrated, e.g. powder form. The protein content of the present beverage preferably is at least 1 wt. %, more preferably at least 2 wt. %, most preferably at least 3 wt. %.

According to a particularly preferred embodiment of the invention the nutritional beverage comprises 0.1-2 wt. % caseinate, e.g. sodium caseinate. The incorporation of caseinate in the indicated amounts was found to effectively stabilise the beverage against coalescence during sterilisation and storage.

The carbohydrates contained in the present beverage preferably include saccharides selected from the group consisting of monosaccharides, disaccharides and combinations thereof. Typically, the amount of saccharides contained in the present beverage is within the range of 0-10 wt. %, preferably within the range of 3-6 wt. %.

In addition, the present beverage may suitably contain maltodextrin, e.g. in an amount of 0-10% by weight of the beverage. Particularly suitable maltodextrins have a DE in the range of 2 to 20. Preferably, the maltodextrin employed in the present beverage has a DE in the range of 10 to 20.

As explained herein before, the incorporation of high levels of carbohydrates favours physical destabilisation of the nutritional beverage. Nonetheless, it was found that stable beverages can be prepared in accordance with the present invention even if these beverages contain at least 6 wt. % or even at least 9 wt. % of carbohydrates.

The nutritional beverage of the present invention is a pourable product. Typically, the present beverage has a viscosity (at 20° C.) in the range of 5-200 mPa·s at 10 s⁻¹. More preferably, the present beverage has a viscosity in the range of 10-100 mPa·s at 10 s⁻¹, most preferably of 10-50 mPa·s, meaning that the product is a thin liquid that can easily be swallowed. The viscosity of the present beverage is suitably determined by means of a Rheometer® AR1000, using a shear rate sweep from 0.01 to 250 s⁻¹ (in 510 s.) and a cone plate measuring system with a cone angle 2:0:38 (deg:min:sec), a cone diameter of 40 mm and a truncation of 54 microns.

The nutritional beverage of the present invention advantageously contains one or more minerals, especially transition metals such as iron and zinc. Typically, the beverage contains at least 10 ppm of iron and/or zinc cations. Preferably, the beverage contains at least 10 ppm iron cations, more preferably at least 20 ppm iron cations. The content of iron cations usually does not exceed 200 ppm, preferably it does not exceed 100 ppm.

Other nutritional components, besides minerals, that may advantageously be incorporated in the present beverage include vitamins, sterols, flavonoids, carotenoids etc.

The fat contained in the present beverage preferably is a liquid non-hydrogenated oil containing at least 60% unsaturated fatty acid residues by weight of the total amount of fatty acid residues contained in said oil. Examples of suitable liquid oils include vegetable oils (sunflower oil, soybean oil, safflower oil etc.) and fish oils.

As explained herein before, the present beverage is an oil-in-water emulsion. The fat is preferably present in said beverage with a as dispersed droplets with an average diameter D_{3,2} of 0.1-3 μm, preferably of 0.3-2 μm. The average diameter D_{3,2} (i.e. the surface weighted average diameter) can suitably be determined by means of laser diffraction, using a Helos™ laser diffraction sensor (ex Sympatec GmbH) in combination with a 632.8 nm laser. Measurements are conducted at 20° C. using a QUIXEL™ wet dispenser ex Sympatec GmbH (at an optical concentration between 10 and 20%).

Typically, the excellent storage stability of the present beverage is evidenced by an increase of the average diameter D_{3,2} of less than 50% when the beverage is stored at 40° C. for one month. Under these severe storage conditions an increase of the average diameter D_{3,2} of less than 200% can readily be achieved in the present nutritional beverage. Preferably, the increase in D_{3,2} observed under these conditions does not exceed 100%, more preferably it does not exceed 80%, most preferably it does not exceed 60%.

The caloric content of the present nutritional beverage typically is in the range of 0.4-1.7 kcal/ml. Most preferably, the caloric content is in the range of 0.7-1.3 kcal/ml. Of the total caloric content, preferably not more than 40% is provided by fat. Preferably, fat represents between 25 and 35% of the total caloric content of the beverage. Typically, carbohydrates and proteins provide between 35-67%, respectively 10-33% of the total caloric content of the beverage.

Another aspect of the invention relates to a process of manufacturing a sterilised nutritional beverage, said method comprising:
combining the protein, fat, starch component, fatty acid emulsifier, hydrocolloid, non-dissolved salt, optional other nutritional components and water in a pre-emulsion;
homogenising the pre-emulsion; and
sterilising the homogenised pre-emulsion by heating it to a temperature of more than 130° C. for 2-30 seconds.

The aforementioned sterilisation conditions are typical of so called ultra high temperature (UHT) sterilisation. UHT sterilisation may suitably be achieved in the present method by either direct or indirect heating.

It is important that homogenisation of the pre-emulsion yields an emulsion with very fine oil droplets. Preferably, the oil droplets in the homogenized pre-emulsion exhibit a mean diameter D_{3,2} of 0.1-3 μm, preferably of 0.3-2 μm. Typically, homogenisation is achieved in the present method at a pressure of at least 8 Mpa. Preferably, the pre-emulsion is homogenised at a pressure in the range of 10-30 Mpa.

The invention is further illustrated by means of the following examples.

### EXAMPLES

### Example 1

A nutritional beverage was prepared on the basis of the following recipe:

| Ingredient | Wt. % |
|---|---|
| Skim milk powder | 5.0 |
| Sodium caseinate | 0.36 |
| Dipotassium phosphate | 0.185 |
| Fat | 2.18 |
| Mono/diglycerides (Cremodan Super, Danisco) | 0.15 |
| Sucrose | 5.0 |
| Native starch (Waxilys 200 ex Roquette) | 1.0 |
| Carrageenan (CL110, Danisco) | 0.025 |
| Iron fumarate | 0.016 |
| Zinc sulphate | 0.008 |
| V/M premix (containing 95.5 wt. % Na-ascorbate) | 0.107 |
| Water | Remainder |

The water was weighed and heated to 80° C. Skimmed milk powder was pre-mixed with potassium phosphate and mono/di-glycerides. This mixture was dispersed in the hot water under high speed mixing and hydrated under proper mixing for 15 minutes. An oil blend-containing 0.95% DHA was produced using Soybean oil and a DHA concentrate based on Algae oil ex Nutrinova in a ratio of 97.8:2.2%. This oil mixture was added under high speed mixing and pre-emulsified by proper mixing for 15 minutes. Next, the maltodextrin, the native starch and carrageenan was dispersed in this pre-emulsion

A blend containing vitamin C, iron salt, zinc salt and V/M premix was added to the pre-emulsion, followed by the sugar. The pH was checked and corrected whenever it was below <6.7 using phosphate buffer. The product was homogenised at 175-250 bar and 65-70° C. and thereafter UHT treated at 140° C.-4 sec. Thereafter the product was cooled to 25-30° C. and filled aseptically in PET bottles (250 ml) with a screw cap.

The emulsion so prepared was stored at 40° C. for 4 months. Slight creaming was observed in these samples after this storage period.

1. A sterilized nutritional beverage product comprising:
a) from 0.5-8.0 wt. % protein;
b) from 0.1-10 wt. % of dispersed fat;
c) from 0.2-4 wt. % of starch component selected from the group consisting of native starch, modified starch and combinations thereof;
d) from 0.01-2.0 wt. % of fatty acid emulsifier;
e) from 0.01-2.5 wt. % of non-dissolved edible salt;
f) from 0.005-0.5 wt. % of a hydrocolloid selected from the group consisting of carrageenan, guar gum, carboxymethyl cellulose, microcrystalline cellulose and combinations thereof;
g) from 0-9.0 wt. % of other nutritional components; and
h) 70-90 wt. % water

2. Nutritional beverage according to claim 1, wherein the fatty acid emulsifier is selected from the group consisting of monoglycerides, diglycerides, esters of monoglycerides and food acids, esters of monoglycerides and food acids and combinations thereof.

3. Nutritional beverage according to claim 1, wherein the fatty acid emulsifier is selected from the group consisting of monoglycerides, diglycerides and combinations thereof.

4. Nutritional beverage according to claim 1, wherein the fatty acid emulsifier has an iodine value of less than 12.

5. Nutritional beverage according to claim 1 wherein the hydrocolloid is a carrageenan.

6. Nutritional beverage according to claim 1, wherein the non-dissolved edible salt is selected from the group consisting of iron salts, calcium salts, zinc salts and combinations thereof.

7. Nutritional beverage according to claim 1, said beverage having a viscosity (at 20° C.) in the range of 5-200 mPa·s at 10 s⁻¹.

8. Nutritional beverage according to claim 1, wherein the fat is present as dispersed droplets with a diameter D_{3,2} of 0.1-3 μm, preferably of 0.3-2 μm.

9. Nutritional beverage according to claim 1, having a pH in the range of 4.7-8.0.

10. A process of manufacturing a sterilised nutritional beverage according to claim 1, said method comprising:
combining the protein, fat, starch component, fatty acid emulsifier, hydrocolloid, non-dissolved salt, optional other nutritional components and water in a pre-emulsion;
homogenising the pre-emulsion; and
sterilising the homogenised pre-emulsion by heating it to a temperature of more than 130° C. for 2-30 seconds.
